(19) United States
(12) Patent Application Publication
(10) Pub. No.: US 2008/0316597 A1
(43) Pub. Date: Dec. 25, 2008

(54) THREE-DIMENSIONAL (3D) DISPLAY

(75) Inventors: Chao-Hsu Tsai, Hsinchu City (TW); Kuen Lee, Hsinchu (TW); Chou-Lin Wu, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 12/129,650

(22) Filed: May 29, 2008

(30) Foreign Application Priority Data
Jun. 25, 2007 (TW) 96122925

(51) Int. Cl. G02B 27/26

(52) U.S. Cl. 359/465; 349/193

(57) ABSTRACT

A 3D display has a light grating unit inserted between a polarized light module and an image display unit. The light grating unit includes a dispersing liquid crystal unit, a microretarder unit, and a polarizing film. By controlling the dispersing liquid crystal unit of the light grating unit to be switched between a dispersing state and a transparent state, a displayed image is switched between a 2D image displaying mode and a 3D image displaying mode. The dispersing liquid crystal unit can be removed, so as to allow the image display unit to stay in the 3D image displaying mode.

### CROSS-REFERENCE TO RELATED APPLICATION

This application claims the priority benefit of Taiwan application serial no. 96122925, filed on Jun. 25, 2007. The entirety of the above-mentioned patent application is hereby incorporated by reference herein and made a part of specification.

### BACKGROUND OF THE INVENTION

1. Field of the Invention

The present invention relates to a three-dimensional (3D) display technology for being able to switch an image to be displayed in a two-dimensional (2D) image displaying mode or in a three-dimensional image displaying mode.

2. Description of Related Art

### Related Art 1

FIG. 1 depicts a cross-sectional view in U.S. Pat. No. 725,567 in 1903. As illustrated in FIG. 1, a light provided by a backlight plate 100 is irradiated to a parallax barrier 101 which is constituted by alternately-arranged transparent and non-transparent vertical stripes. Thereby, the light in a stripe shape is irradiated at intervals. Thereby, since pixels of a transmission-type image display unit 102 correspond to human visual systems, a first image is then received by one human eye, whereas a second image is received by the other. This is a 3D autostereoscopic technology through which discrete 3D-images can be received by the left eye and the right eye of an observer, respectively. As shown in FIG. 1, only odd column pixels 01, 03, 05, 07 and 09 are received by the left eye, while even column pixels 02, 04, 06, 08 and 10 are merely received by the right eye. As such, the 3D images are constructed in the human visual system.

### Related Art 2

FIG. 2 illustrates another prior art whose structure differs from the structure depicted in FIG. 1. Namely, in FIG. 2, positions of the parallax barrier 101 and the transmission-type image display unit 102 are exchanged. As shown in FIG. 2, the transmission-type image display unit 102 is disposed between the backlight plate 100 and the parallax barrier 101, while the transmission-type image display unit 102, the backlight plate 100 and the parallax barrier 101 are disposed at the same side in FIG. 1. However, same effects can still be achieved according to the illustration in FIG. 2 as those accomplished based on the depiction in FIG. 1.

### Related Art 3

In still another prior art disclosed in U.S. Pat. No. 7,116,387, as shown in FIGS. 3A and 3B, two microretarder plates 2 and 3 respectively having a phase retardation of 0 and a half-wavelength phase retardation which are vertically interlaced are horizontally moved. The horizontal relative movement of the two microretarder plates 2 and 3 is able to switch between a state in which the parallax barrier exists and a state in which the parallax barrier does not exist. Thereby, the 2D images and the 3D images can be swapped over due to the horizontal movement of the microretarder plates and the incorporation of a polarizer. FIGS. 3A and 3B illustrate a transparent liquid crystal panel 1, two microretarder plates 2 and 3, a polarizer 4, a backlight module 5, two driving devices 6 and 7, and a carrier 8.

In FIG. 3A, a 2D image outputting mode is depicted. As phase retardation patterns of the two microretarder plates 2 and 3 are superposed with each other, the polarized lights can thoroughly penetrate the two microretarder plates 2 and 3, such that the 2D image may be displayed by the display unit 1. By contrast, FIG. 3B illustrates a 3D image outputting mode. When the phase retardations patterns of the two microretarder plates 2 and 3 are alternately arranged, the lights in the stripe shape are outputted at intervals since the two microretarder plates 2 and 3 respectively have the phase retardation of 0 and the phase retardation of λ/2. As such, the 3D image is displayed by the display unit 1, and it is likely to switch between the 2D image displaying mode and the 3D image displaying mode.

### SUMMARY OF THE INVENTION

The present invention is directed to a 3D display in which a microretarder plate is adopted, and a dispersing liquid crystal panel may be electrically switched, so that the display can be switched between a 2D image displaying mode and a 3D image displaying mode, for example. Both the microretarder plate and the dispersing liquid crystal panel may be manufactured in a thin film type, and the space requirement may be very small between the microretarder plate and the dispersing liquid crystal panel, for example. Accordingly, a thickness and a weight of the panel may be significantly reduced. Further, there is no moving part while switching between the 2D image displaying mode and the 3D image displaying mode. This could cause to an integrally stacked structure with small volume and mechanical strength, which is suitable for compact or portable apparatuses.

The present invention provides a 3D display in which a light grating unit is inserted between a polarized light module and an image display unit. The light grating unit includes a polarized light modulation unit, a microretarder unit, and a polarizing film. The polarized light modulation unit may be a dispersing liquid crystal unit. By controlling the “dispersing liquid crystal unit” of the light grating unit to be switched between a “dispersing” state and a “transparent” state, an image to be displayed is switched between a 2D image displaying mode and a 3D image displaying mode. The dispersing liquid crystal unit may also be omitted in the present invention. In other words, the light grating unit formed from the microretarder unit and the polarizing film is disposed between the polarized light module and the image display unit, such that the image display unit is in the 3D image displaying mode. In addition, the polarizing film of the light grating unit may be omitted given that the image display unit already includes the polarizing film facing one side of the light grating unit.

According to the present invention, the polarized light module is employed to output polarized lights. With a combination of the microretarder unit and the polarizing film, the polarized lights are outputted at intervals, such that the image display unit displays a first image in one part of the display elements a second image in another part of the display elements, and so on. The first image can be received by one human eye of an observer, whereas the second image can be received by the other, and so on. Accordingly, the 3D image is generated in the visual system of the observer. Here, the description is the principle for one observer at a position. However, when multiple observers are viewing the image or the observer is moving, for example, then several viewing zones can be setup. In other words, based on the light grating unit, it just needs two images, as the first image and the second image with a parallax, to enter two eyes of an observer. The image displaying device can accordingly display multiple images with different parallax for different viewing zones, so that the multiple images with respect to multiple view angles can be displayed.

In order to make aforementioned and other objects, features and advantages of the present invention comprehensible, several embodiments accompanied with figures are described in detail below. It is to be understood that both the foregoing general description and the following detailed description are exemplary, and are intended to provide further explanation of the invention as claimed.

### BRIEF DESCRIPTION OF THE DRAWINGS

FIG. 1 is a schematic view illustrating a 3D display mechanism utilizing a conventional light grating.

FIG. 2 is a schematic view illustrating another conventional 3D display mechanism.

FIGS. 3A to 3B are schematic views illustrating still another conventional 3D image display which can be switched between a 2D image displaying mode and a 3D image displaying mode.

FIG. 4 is a schematic cross-sectional view illustrating a structure of a 3D display according to an embodiment of the present invention.

FIGS. 5A through 5D are schematic views illustrating a displaying mechanism of the 3D display according to an embodiment of the present invention.

FIG. 6 is a schematic view illustrating an operating mechanism of the 3D display corresponding to a 2D image displaying mechanism according to an embodiment of the present invention.

FIGS. 7 through 12 are schematic cross-sectional views illustrating the 3D display according to other embodiments of the present invention.

FIGS. 13-15 are schematic cross-sectional views further illustrating the 3D display in applications with viewing zones, according to other embodiments of the present invention.

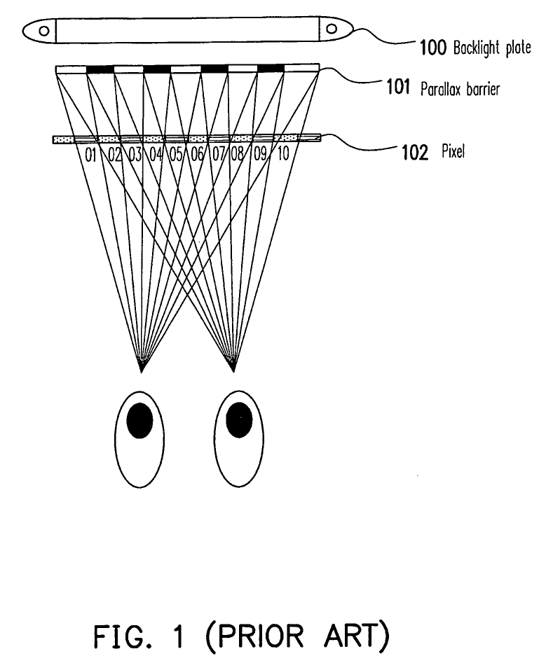

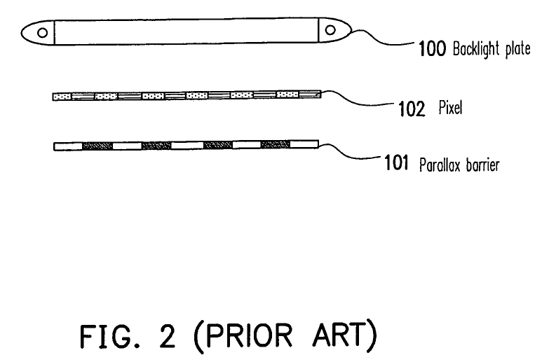

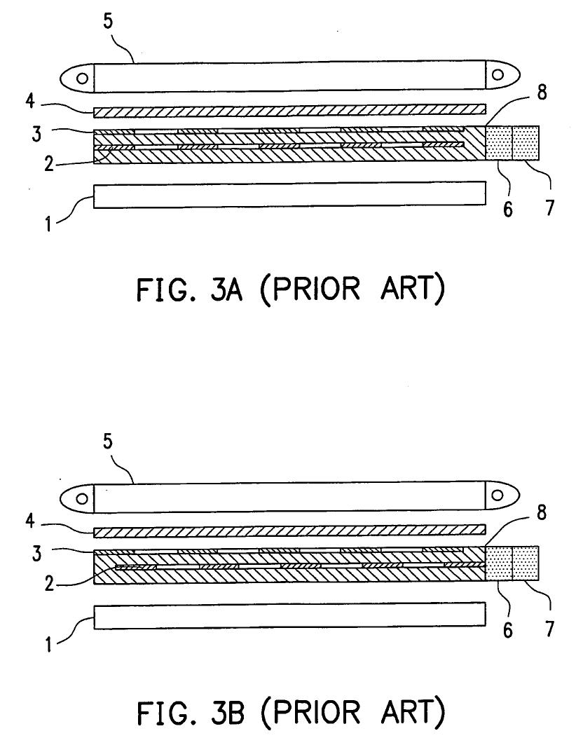

### DESCRIPTION OF EMBODIMENTS

### First Embodiment

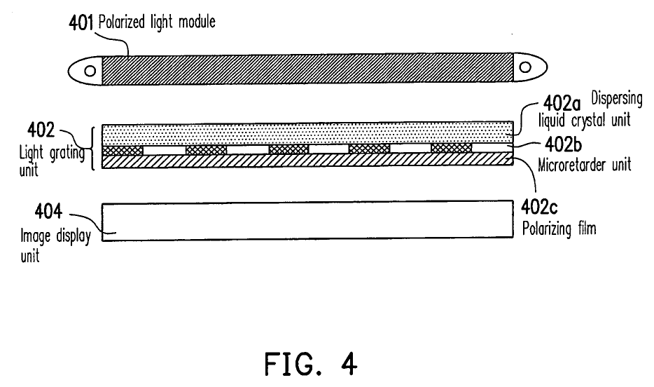

FIG. 4 is a schematic cross-sectional view illustrating a structure of a 3D display according to an embodiment of the present invention. A polarized light module 401 provides a light source having the same polarization properties. Through a light grating unit 402, a polarized light in a stripe shape is outputted at intervals. Thereafter, an image display unit is employed to display a first image in one part of the display panel elements and a second image in another part of the display panel elements, and so on. The first image can be received by one eye of an observer, whereas the second image can be received by the other, and so on. A 3D image is then constructed. According to the present embodiment, the image display unit is, for example, a transmission-type image display unit 404. The light grating unit 402 includes a dispersing liquid crystal unit 402a, a microretarder unit 402b, and a polarizing film 402c.

The dispersing liquid crystal unit 402a is used as a polarization control unit to modulate the polarization of the polarized light emitted from the polarized light module. Besides, the dispersing liquid crystal unit 402a is able to be switched between a dispersing state and a transparent state. As the dispersing liquid crystal unit 402a is switched to the transparent state, the polarized light whose polarization stays unchanged passes through the dispersing liquid crystal unit 402a. On the other hand, as the dispersing liquid crystal unit 402a is switched to the dispersing state, the polarized light becomes a non-polarized light while passing through the dispersing liquid crystal unit 402a.

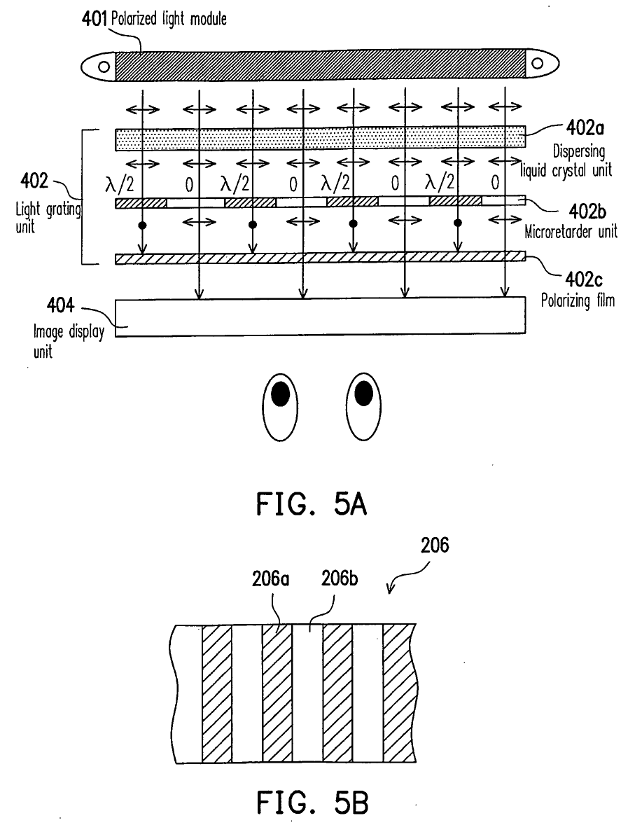

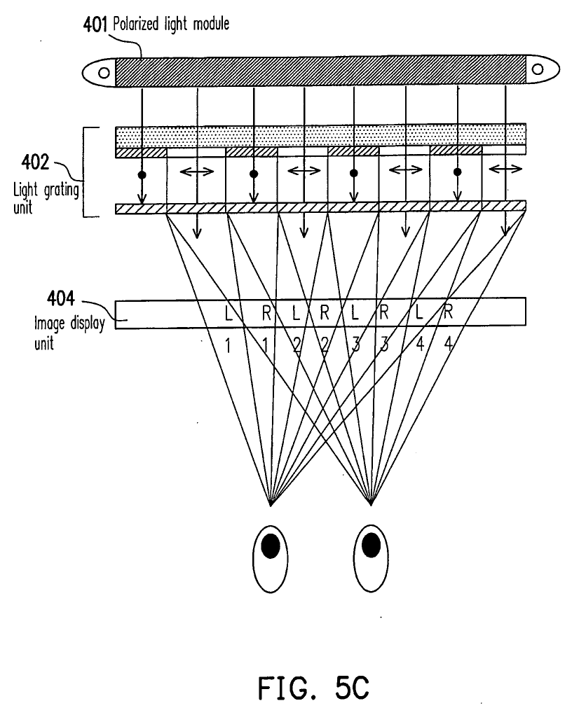

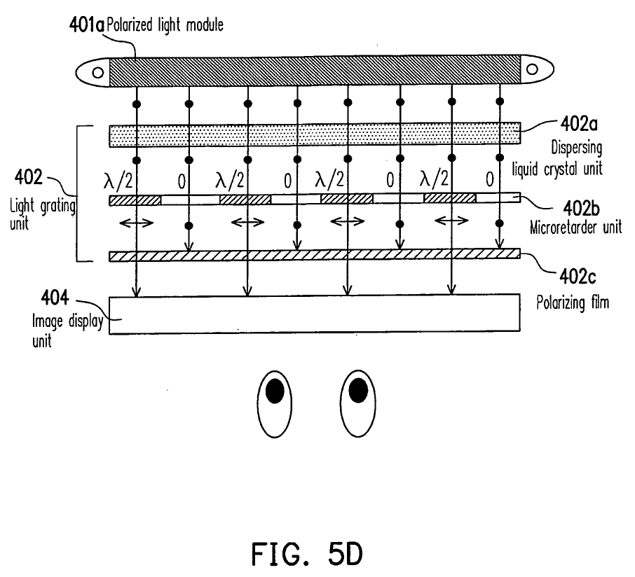

FIG. 5A demonstrates Principle 1 of operating the 3D display depicted in FIG. 4. As a polarization direction of the polarized light generated by the polarized light module 401 is identical to a polarization direction of the polarized light of the polarizing film 402c, the polarized light generated by the polarized light module 401 is inputted into the light grating unit 402. Then, when the dispersing liquid crystal unit 402a is switched to the 3D image displaying mode, the dispersing liquid crystal unit 402a is controlled to be in the transparent state, such that polarization property of the inputted light is reserved.

When a direction of the polarized light generated by the polarized light module 401 is identical to a direction of the polarized light of the polarizing film 402c, and the polarized light produced by the polarized light module 401 passes through a stripe area having a phase retardation of λ/2 in the microretarder unit 402b, the polarization direction of the polarized light generated by the polarized light module 401 is rotated at 90 degrees. As such, a non-transparent area is formed. Simultaneously, as the polarized light passes through a stripe area having a phase retardation of 0, the polarized light having the same polarization direction is able to penetrate the polarizing film 402c, and thus a transparent area is formed.

FIG. 5B illustrates a microretarder unit 206 used in an embodiment of the present invention. The microretarder unit 206 has a plurality of stripe-shaped first areas 206a and a plurality of stripe-shaped second areas 206b arranged in an interlaced fashion. For example, the first areas 206a have a phase retardation of λ/2, while the second areas 206b have a phase retardation of 0. It is likely to exchange the first areas 206a and the second areas 206b, which depends on actual demands. The polarized light passing through the first areas 206a is rotated at 90 degrees, such that the light passing through the first areas 206a and the second areas 206b have respective polarization states perpendicular to each other. Indeed, the phase retardation difference between the first areas 206a and the second areas 206b of the microretarder unit 206 should remain λ/2.

After passing through the stripe-shaped areas respectively having the phase retardation of 0 and the phase retardation of λ/2 in the microretarder unit 402b, the polarized lights in the same polarization direction are separated into two kinds of the polarized lights perpendicular to each other, and then the two kinds of the polarized lights are outputted with alternate distribution. Thereafter, through the polarizing film 402c, the polarized lights are filtered, such that stripe-shaped transparent and non-transparent lights are formed and outputted. Here, an array of opaque lines is formed by the light grating unit 402, and different sets of images shown by the image display unit 404 are then received by eyes of an observer, so as to construct a 3D image.

FIG. 5C depicts an imaging principle of the 3D image as shown in FIG. 5A. According to FIG. 5C, pixels L1, L2, L3 and L4 are received by the left eye of the observer, while pixels R1, R2, R3 and R4 are received by the right eye thereof, such the 3D image is established. Here, the description is the principle for one observer at a position. However, when multiple observers are viewing the image at the image display unit 404 or the observer is moving in observing the image display unit 404, for example, then several viewing zones can be setup. In other words, based on the light grating unit 402, it just needs two images, as the first image and the second image with a parallax, to enter two eyes of an observer. However, the image display unit 404 can accordingly display multiple images with different parallax for different viewing zones, so that the multiple images with respect to multiple view angles can be displayed. Here in FIG. 5C, the pixels L1, L2, L3, L4, . . . form one viewing zone image, the pixels R1, R2, R3, R4 . . . form another viewing zone image. Similarly, more viewing zone can be displayed. Actually, without specifying left L and right R, more viewing zone images can be displayed at the image display unit 404. Any two of the viewing zone images form the left image L and the right image R for one observer, so as to produce 3D effect. The embodiments in the invention just take left and right images for easy description.

FIG. 5D demonstrates Principle 2 of operating the 3D display depicted in FIG. 4. As the direction of the polarized light generated by the polarized light module 401 is perpendicular to the direction of the polarized light of the polarizing film 402c, and the polarized light produced by the polarized light module 401 passes through the stripe area having the phase retardation of 0 in the microretarder unit 402b, the polarized light is not able to pass through the polarizing film 402c, and thus the non-transparent area is formed. Simultaneously, when the polarized light passes through the stripe area having the phase retardation of λ/2, the polarized light is rotated at 90 degrees and is able to penetrate the polarizing film 402c, leading to a formation of the transparent area. Other operating principles are similar to those presented by FIG. 5A.

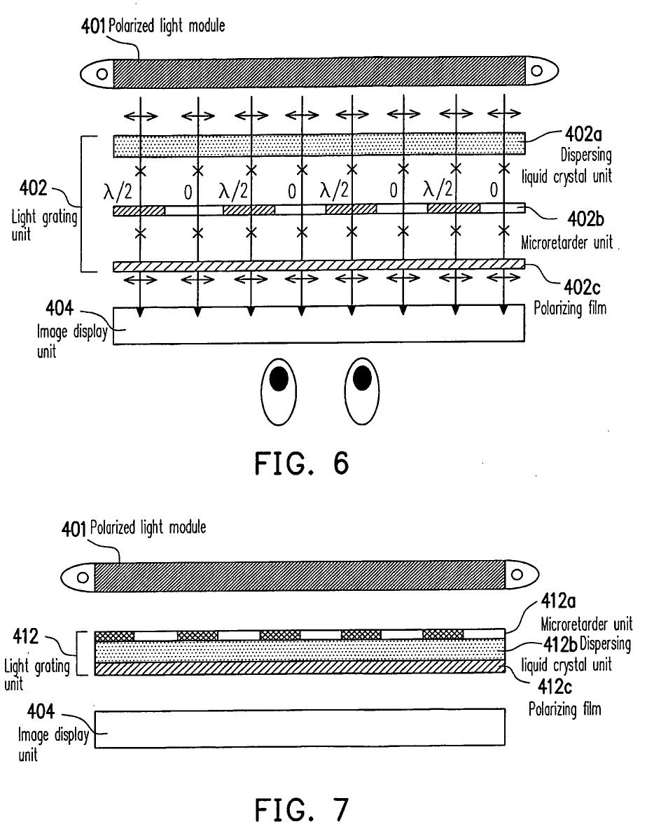

FIG. 6 illustrates a 2D image displaying mode of the image display depicted in FIG. 5A. The polarized light generated by the polarized light module 401 enters the light grating unit 402. By controlling the dispersing liquid crystal unit 402a to be in the dispersing state, the polarized light passing through 402a becomes random polarized. Therefore, the light having no special polarization property does not generate functional optical effects after the light passes through the microretarder unit 402. Hence, no parallax barrier is formed by the light grating unit 402. After that, only one polarized light is allowed to penetrate the polarizing film 402c and enter the observer's eyes through the image display unit 404. Thereby, the observer can completely view the 2D image.

### Second Embodiment

As illustrated in FIG. 7, a light grating unit 412 is constituted by stacking a microretarder unit 412a, a dispersing liquid crystal unit 412b and a polarizing film 412c in sequence. The difference between FIG. 7 and FIG. 6 lies in that the dispersing liquid crystal unit 412b of the light grating unit 412 is disposed between the microretarder unit 412a and the polarizing film 412c. The operating principles of the dispersing liquid crystal unit 412b in the 2D image displaying mode and in the 3D image display mode are the same as the operating principles previously described in FIGS. 5 and 6.

The polarized lights generated by the polarized light module 401 are inputted into the light grating unit 412. Then, as the polarized lights are switched to the 3D image displaying mode, the polarized lights having the same polarities pass through the microretarder unit 412a and are separated into the polarized lights with two polarization states perpendicular to each other. Thereafter, when the polarized lights pass through the dispersing liquid crystal unit 412b configured in the transparent state, the polarization properties of the lights inputted into the microretarder unit 412a are reserved. Next, through the polarizing film 412c, the polarized lights are filtered, such that the parallax barriers having transparent and non-transparent vertical stripes are formed. As such, parts of the lights may respectively enter the left and the right eyes of the observer by means of the image display unit 404, so as to construct the 3D image according to the visual characteristics of human eyes.

The same polarized lights generated by the polarized light module 401 are inputted into the light grating unit 412. Then, as the light grating unit 412 is switched to the 2D image displaying mode, the polarized lights having the same polarities pass through the microretarder unit 412a and are separated into the polarized lights with the two polarization states perpendicular to each other. Thereafter, when the polarized lights pass through the dispersing liquid crystal unit 412b configured in the dispersing state, the polarization properties of the lights inputted into the microretarder unit 412a are no longer reserved. Next, through the polarizing film 412c, the polarized lights are filtered and enter the eyes of the observer by means of the image display unit 404, so as to construct the 2D image.

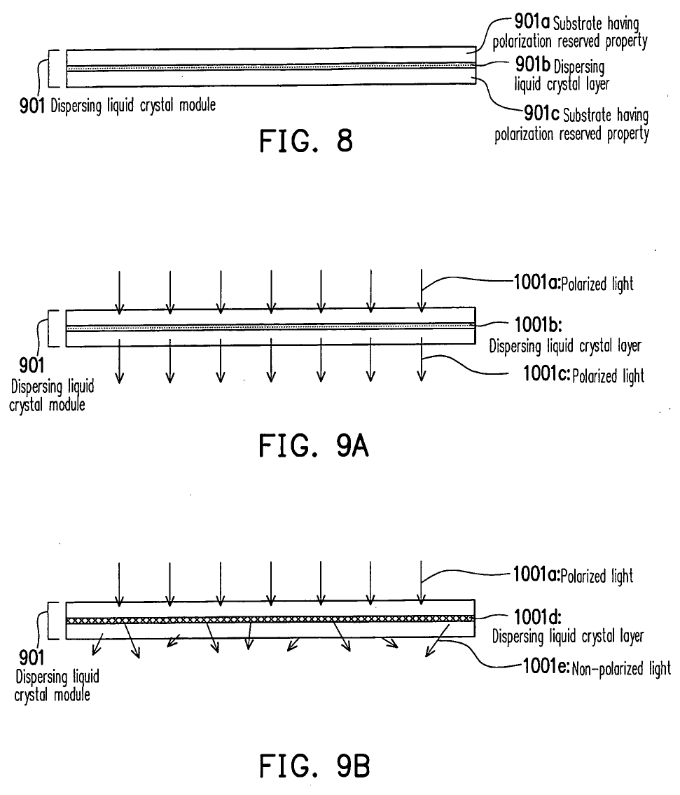

FIG. 8 is a schematic view illustrating a dispersing liquid crystal protection layer. The dispersing liquid crystal units 402a and 412b illustrated in FIGS. 6, 7 and 8 may be protected by adding one protection layer at a top and a bottom of each of the dispersing liquid crystal units 402a and 412b, so as to improve the reliability. The protection layer is made of transparent materials having the polarization reserved properties.

According to FIG. 8, a dispersing liquid crystal module 901 is characterized by a sandwich structure. Namely, the dispersing liquid crystal module 901 is formed by an upper substrate, a lower substrate, and a liquid crystal layer 901b sandwiched therebetween. The upper substrate and the lower substrate are formed by the transparent materials 901a and 901c having the polarization reserved properties, and the transparent materials 901a and 901c can be glass, plastic, transparent plates, thin films, and so forth.

According to FIG. 9A, in the dispersing liquid crystal module 901, as a dispersing liquid crystal unit 1001b is switched to the “transparent” state, an inputted polarized light 1001a in line with the upper and the lower substrates has the polarization reserved property, and so does an outputted polarized light 1001c.

According to FIG. 9B, in the dispersing liquid crystal module 901, as the dispersing liquid crystal unit 1001b is switched to the “dispersing” state, a direction of the inputted polarized light 1001a is dispersed, and a non-polarized light 1001e is then formed and outputted.

### Third Embodiment

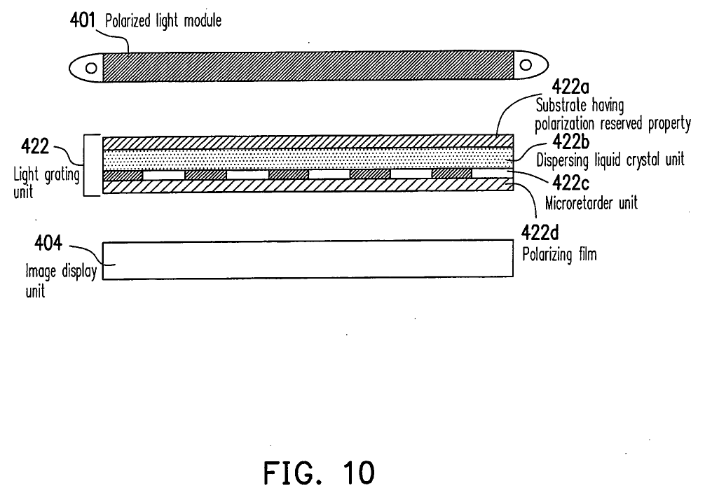

FIG. 10 depicts still another embodiment of the present invention. In FIG. 10, a light grating unit 422 includes a substrate 422a having the polarization reserved property, a dispersing liquid crystal unit 422b, a microretarder unit 422c and a polarizing film 422d. The substrate 422a is, for example, made of glass, plastic, transparent plates, thin films, and so on. Here, FIG. 10 depicts a structure constituted by the substrate 422a having the polarization reserved property as the upper substrate, the microretarder unit 422c as the lower substrate, the dispersing liquid crystal unit 422b sandwiched therebetween, and the polarizing film 422d.

### Fourth Embodiment

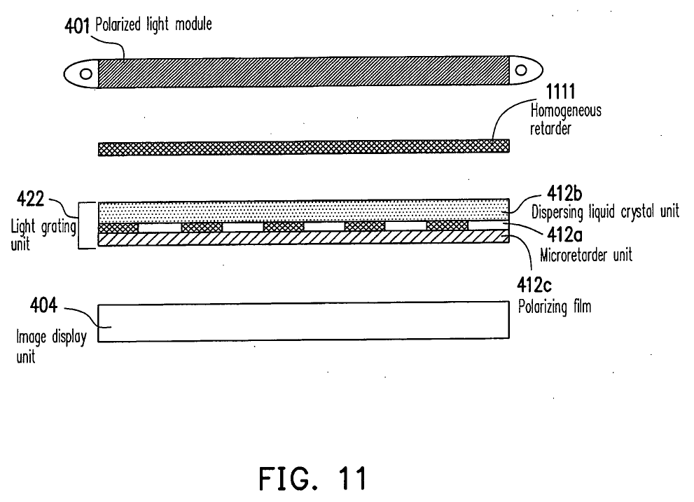

FIG. 11 illustrates a homogeneous retarder 1111 which is additionally disposed on a light emitting surface of the polarized light module 401. The homogeneous retarder 1111 has no patterns, and a drawing direction of the homogeneous retarder 1111 is perpendicular to a drawing direction of the microretarder unit 412a. As demonstrated in FIG. 5A, the nontransparent area of the parallax barrier has the phase retardation of λ/2. Since the microretarder unit 412a cannot achieve the phase retardation of λ/2 at all wavelengths, light leakage may occur in partial. By contrast, in FIG. 5D, the non-transparent area of the parallax barrier has the phase retardation of 0, and light leakage may still occur due to inevitable residue of phase retardation during the fabrication of the microretarder unit 412a. Based on the above, the homogeneous retarder 1111 including no patterns and having the drawing direction perpendicular to the drawing direction of the microretarder unit 412a is added to transform the non-transparent area of the parallax barrier in FIG. 5D into the area having the phase retardation of λ/2 in the microretarder unit 412a. After superposing the homogeneous retarder 1111 including no patterns with the area having the phase retardation of λ/2 in the microretarder unit 412a, a homogeneous area having no phase retardation is then constructed. Thereby, the drawback that the microretarder unit 412a cannot achieve the phase retardation of λ/2 at all wavelengths can be reduced, and light leakage arisen from the residue of phase retardation during the fabrication of the microretarder unit can be reduced as well. Here, “the perpendicular drawing direction” is an ideal condition. However, since inaccuracy may occur during actual fabrication, the drawing direction of the homogeneous retarder 1111 may be substantially perpendicular to that of the microretarder unit according to the present invention.

In FIG. 11, the homogeneous retarder 1111 is disposed between the polarized light module 401 and the dispersing liquid crystal unit 412b, yet the position of the homogeneous retarder 1111 is not limited in the present invention. In other words, the homogeneous retarder 1111 may be disposed between the dispersing liquid crystal unit 412b and the microretarder unit 412a, or disposed between the microretarder unit 412a and the polarizing film 412c.

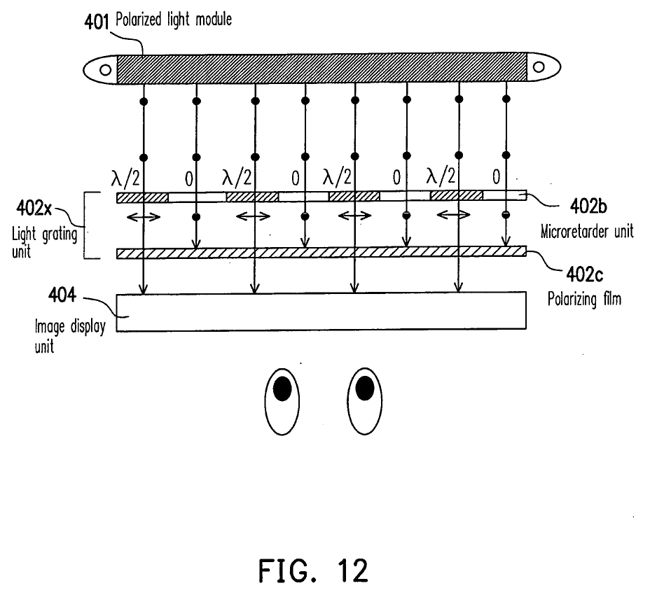

FIG. 12 illustrates a 3D display including the polarized light module 401 for outputting the polarized light and a light grating unit 402x disposed in an outputting light path of the polarized light. In combining the microretarder unit 402b and the polarizing film 402c, the polarized light is vertically outputted at intervals. Here, the microretarder unit 402b modulates the polarized light passing therethrough with use of two parts of materials having a 90-degree phase retardation. Since the materials are alternately arranged at intervals, the polarized light may pass at intervals. Here, 90 degree is an ideal condition. However, since inaccuracy may occur during actual fabrication, the materials may have substantially 90-degree phase retardation according to the present invention. In addition, the 3D display further includes the transmission-type image display unit 404 for outputting a first image in odd column pixels and a second image in even column pixels.

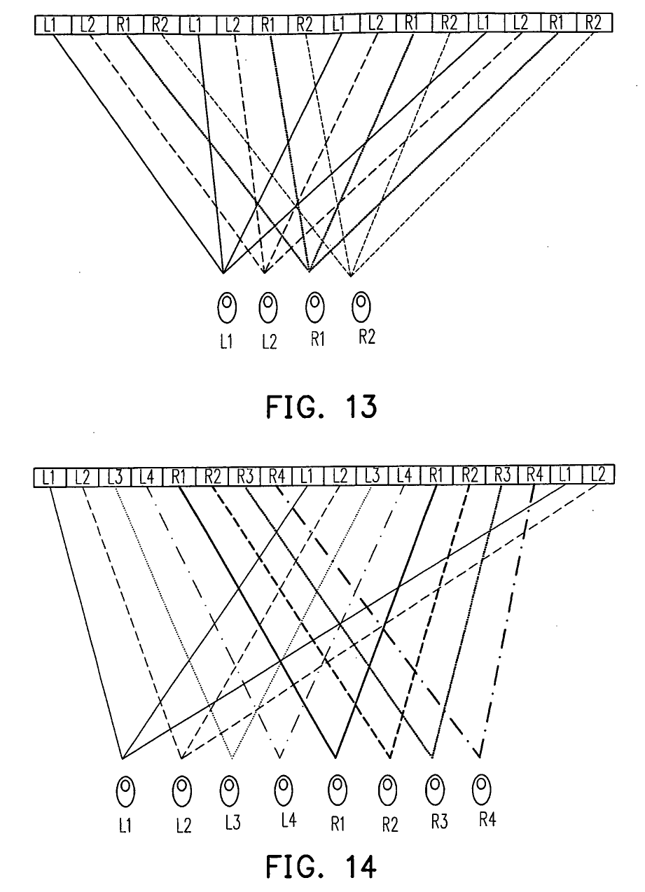

With the same design principle, the 3D image can be created in more applications with more viewing zones, allowing to have the 3D image at different positions and therefore allowing multiple observers to view the 3D image. Like the mechanism in FIG. 5C, more viewing zones can be created. FIGS. 13-15 are schematic cross-sectional views further illustrating the 3D display in applications with viewing zones, according to other embodiments of the present invention. In FIG. 13, the image display unit 404, depending on resolutions, has multiple column pixels. It can be arranged into more sets of column pixels for more images. In this example, it is arranged into four sets of column pixels, indicated as L1, L2, R1 and R2, in which “L” represent left eye and “R” represent right eye, for example. The column pixels at L1 and R1 can form a 3D image. However, if the observer moves to the position at corresponding to column pixels at L2 and R2, then the 3D image still remains. Alternatively, one observer views the 3D image at position of L1 and R1, and another observer can also view the different 3D image at position of L2 and R2.

Even further in FIG. 14, if the design is for more observers or more viewing zones, the 8 viewing zones are created, as the example. In this situation, one of arrangements is grouping into (L1, R1), (L2, R2), (L3, R3) and (L4, R4). In this situation, for example, four observers can view four different 3D images at different viewing position. Alternatively, any observer at the positions of (L1, R1), (L2, R2), (L3, R3) and (L4, R4) can see the 3D image.

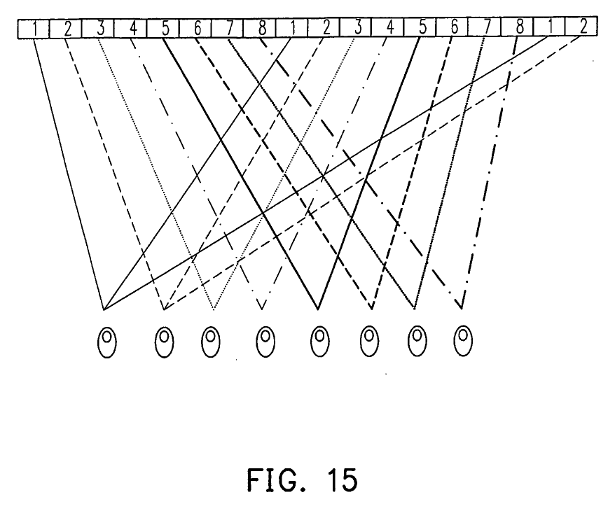

Even further in FIG. 15, based on the 3D display mechanism, it is not necessary to indicate to the right eye and left eye. Actually, any two eyes located at two different viewing zones, the 3D image can be created. In this embodiment, eight sets of column pixels are display, corresponding to eight viewing zones, without specifically assigned to left eye and right eye. The number of observers is also not limited to one. For example, four observers may view the 3D image at the same time. Actually in more general, it is not necessary to limit to eight sets of column pixels corresponding to eight viewing zones. The number of viewing zones is depending on the choice of intended resolution. It only needs to locate the positions of two eyes to simultaneously view any two different viewing zones, and then a 3D image can be created. This would also allow any observer to move to other positions. As a result, any observer can freely move.

In other words, the image display unit in associating with the light grating unit can output the polarized light as at least a first image displayed in first-set column pixels and a second image displayed in second-set column pixels. Optionally, more images at different viewing zones can be produced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A three-dimensional (3D) display, comprising:
a polarized light module outputting a polarized light;
a light grating unit disposed in a light path of the polarized light for modulating and outputting the polarized light at intervals; and
an image display unit for outputting the outputted polarized light as at least a first image displayed in first-set column pixels and a second image displayed in second-set column pixels.

2. The 3D display according to claim 1, wherein the first-set column pixels are odd column pixels and the second-set column pixels are even column pixels.

3. The 3D display according to claim 1, wherein the image display unit outputs multiple images respectively displayed in multiple column pixels corresponding to multiple viewing zones, wherein when two eyes of an observer simultaneously view two of the images at two of the viewing zones, a 3D image is created.

4. The 3D display according to claim 1, wherein the light grating unit further comprises:
a microretarder unit having a first phase modulation material and a second phase modulation material alternately arranged at intervals, wherein the first phase modulation material and the second phase modulation material respectively modulate a phase of the polarized light and output the modulated polarized light; and
a polarizing film allowing a passage of a designated polarized light.

5. The 3D display according to claim 1, wherein the light grating unit further comprises:
a polarized light modulation unit disposed between the polarized light module and the polarizing film, the polarized light modulation unit being switched between a first state and a second state,
wherein the polarized light having polarization reserved property without changes passes through and is emitted out of the light grating unit when the polarized light modulation unit is switched to the first state, and the polarized light is transferred to a non-polarized light and is then emitted when the polarized light modulation unit is switched to the second state.

6. The 3D display according to claim 5, the polarized light modulation unit comprising a dispersing liquid crystal unit capable of being switched between a transparent state and a dispersing state, wherein
(a) the polarized light having polarization reserved property without changes passes through and is emitted out when the dispersing liquid crystal unit is switched to the transparent state; and
(b) the polarized light is transferred to a non-polarized light and is emitted when the dispersing liquid crystal unit is switched to the dispersing state, such that the light grating unit is in a homogenous state without generating a parallax barrier, and the image display unit displays a 2D image.

7. The 3D display according to claim 6, wherein the dispersing liquid crystal unit is disposed between the polarized light module and the microretarder unit.

8. The 3D display according to claim 6, wherein the dispersing liquid crystal unit is disposed between the microretarder unit and the polarizing film.

9. The 3D display according to claim 6, further comprising an upper transparent material having the polarization reserved property and disposed on a first surface of the dispersing liquid crystal unit.

10. The 3D display according to claim 9, further comprising a lower transparent material having the polarization reserved property and disposed on a second surface of the dispersing liquid crystal unit.

11. The 3D display according to claim 4, wherein the first phase modulation material and the second phase modulation material have substantially 90-degree phase retardation.

12. The 3D display according to claim 4, further comprising:
a homogeneous retarder having a drawing direction substantially perpendicular to a drawing direction of the microretarder unit, the homogeneous retarder being disposed between the polarized light module and the microretarder unit.

13. A dual-mode image display, comprising:
a polarized light module for providing a light source in a polarizing state;
a display unit for correspondingly displaying a 2D image or a 3D image; and
a light grating unit disposed between the polarized light module and the display unit, wherein the light grating unit comprises a liquid crystal plate for correspondingly displaying the 3D image in a transparent state or displaying the 2D image in a dispersing state.

14. The dual-mode image display according to claim 13, wherein the polarized light module is integrally-structured, and the polarized light module in the polarizing state is obtained through a polarizing film.

15. The dual-mode image display according to claim 13, wherein the light grating unit has a polarizing film facing a side of the display unit.

16. The dual-mode image display according to claim 13, wherein the liquid crystal plate is located in a fixed position.

17. The dual-mode image display according to claim 13, wherein the light grating unit further comprises:
a microretarder unit having a first area and a second area, wherein a parallax barrier is formed in the first area and the second area when the liquid crystal plate is in the transparent state, and no parallax barrier is constructed in the first area and the second area when the liquid crystal plate is in the dispersing state.

18. The dual-mode image display according to claim 17, wherein the first area and the second area of the microretarder unit have a half-wavelength (λ/2) phase retardation, such that the first and the second areas have respective polarizing states perpendicular to each other.

19. The dual-mode image display according to claim 17, wherein the microretarder unit is disposed between the liquid crystal plate and the polarized light module.

20. The dual-mode image display according to claim 17, wherein the liquid crystal plate is disposed between the microretarder unit and the polarized light module.

21. The dual-mode image display according to claim 13, further comprising:
a homogeneous retarder having a drawing direction perpendicular to a drawing direction of the microretarder unit, the homogeneous retarder being disposed between the polarized light module and the microretarder unit.

22. A dual-mode image display, comprising:
a polarized light module for providing a light source in a polarizing state;
a homogeneous retarder having a first drawing direction to generate a first phase retardation;
a liquid crystal plate which is controlled to be in a transparent state or in a dispersing state;
a microretarder unit having a first area and a second area, wherein a parallax barrier is formed in the first area and the second area when the liquid crystal plate is in the transparent state, and no parallax barrier is constructed in the first area and the second area when the liquid crystal plate is in the dispersing state, the drawing direction of the homogeneous retarder being perpendicular to a drawing direction of one of the first area and the second area; and
a display unit for correspondingly displaying a 2D image or a 3D image,
wherein the homogeneous retarder, the liquid crystal plate and the microretarder unit are disposed between the polarized light module and the display unit.

23. The dual-mode image display according to claim 22, wherein the first area and the second area of the microretarder unit have a phase retardation of λ/2, such that the first and the second areas have respective polarizing states perpendicular to each other.

24. The dual-mode image display according to claim 22, wherein the light grating unit has a polarizing film facing a side of the display unit.

25. The dual-mode image display according to claim 22, wherein one of the first area and the second area of the microretarder unit has no phase retardation, and the other of the first area and the second area generates a phase retardation of λ/2.

26. The dual-mode image display according to claim 22, wherein the liquid crystal plate is located in a fixed position.
